(19) United States
(12) Patent Application Publication
(10) Pub. No.: US 2007/0237029 A1
(43) Pub. Date: Oct. 11, 2007

(54) Frequency matched relative position tracking system

(75) Inventor: Richard Watson, Madison, AL (US)

Correspondence Address: LANIER FORD SHAVER & PAYNE P.C., P O BOX 2087, HUNTSVILLE, AL, 35804, US

(73) Assignee: HUP, LLC, Franklin, TN (US)

(21) Appl. No.: 11/582,646

(22) Filed: Oct. 18, 2006

Related U.S. Application Data
(60) Provisional application No. 60/790,042, filed on Apr. 7, 2006.

(51) Int. Cl. G01S 3/80

(52) U.S. Cl. 367/120

(57) ABSTRACT

A method and system for relative positional tracking of a signal source is disclosed that requires no phase synchronization between the tracked source and tracking system. A signal source transmits a repeating signal. The virtual wavelength of the repeating signal establishes zones of coverage. The system's sampling rate (or sync clock) corresponds to the frequency of the repeated signal. One or more ultrasonic transceivers placed within the desired coverage area capture the transmitted signal. Before tracking begins, a coordinate system origin (X=0, Y=0, Z=0) is established so that all tracking calculations are relative to the origin. Relative time-of-flight measurements are made by comparing the received signals against a sync clock. Tracking is accomplished by triangulating distance measurements received from the ultrasonic transceivers.

### REFERENCE TO RELATED APPLICATIONS

This application claims priority to Provisional Patent Application U.S. Ser. No. 60/790,042, entitled “Relative Position Tracking System,” and filed Apr. 7, 2006, which is fully incorporated herein by reference.

### BACKGROUND OF THE INVENTION

Light, sound, and electromagnetic waves can be used to track an object, with each presenting a unique set of challenges and limiting factors. Ultrasound offers the advantages of low cost, parts availability, established safety record, and license free operation. Light and electromagnetic waves offer the advantage of speed.

Measuring distance to a target is the most fundamental requirement of a tracking system. Using ultrasound to measure distance is straightforward and well documented.

The most common method involves transmitting a short burst of ultrasound towards a target and timing how long it takes for an echo to return. The measured time is proportional to the distance traveled by the sound pulse and is called time-of-flight (TOF). By multiplying the TOF value with the speed of sound an accurate distance measurement to the target and back is established. Dividing the result by 2 gives the distance to the target from the transmitter. This method is slow, requiring that a signal travel to the target and back again. At room temperature it would take about 21.2 ms for a sound pulse to travel 12′ and back resulting in a maximum measuring rate of 47 times per second. A faster and less common method involves attaching an ultrasonic source to the target. By having the target transmit an ultrasonic source signal (USS) to the receiver the TOF is effectively cut in half. One significant drawback to this method is that the ultrasonic source and receiver must be phase synchronized in order to establish a valid TOF. Known techniques for synchronization require that the transmitter and receiver share a common clock or that a separate timing signal be transmitted using light or radio waves. Another method involves locking onto an external signal source such as a local AM broadcast. Although these methods are effective, they are also overly restrictive or unnecessarily complicated. Moreover, while the use of ultrasound to measure distance is widely appreciated, its value in 3D tracking is relatively unexamined.

A number of tracking systems are known in the art. For example, U.S. Pat. No. 6,424,334, discloses a representation of a glove on a display screen. The spatial position of the glove assembly is determined by the time delay between transmission of an ultrasonic signal by a transducer in the glove and the reception of that signal by the receivers of the position sensing receiver assembly. However, the position and orientation of the fingers is transmitted to an interface circuit via conductive cable or other known technique such as radio. Also, the circuits for initiating the transmitted signal derives from the host computer as well as the measurement of time between when the signal was transmitted and received. Additionally, the receivers are disposed about the computer screen.

U.S. Pat. No. 6,628,270, issued to Sekiguchi et al, discloses a coordinate input apparatus, comprising an input device having an ultrasonic transmitter and two ultrasonic receivers which are aligned in a direction not perpendicular to a plurality of input planes. The disclosure requires a synchronizing means for synchronizing the input device with the ultrasonic receiver. The receivers are also in predetermined positions.

U.S. Pat. No. 6,798,403, issued to Kitada et al, discloses a system for detecting a position of a stylus movable on an interactive board which includes a position information transmitter and an information detective device. This stylus has a transmitter for transmitting to the detection sections electromagnetic wave signals or light signals and ultrasonics wave signals. The position is detected based on measurement of direct distances for signal transmission between the stylus and the detection signals. The light signal or electromagnetic wave signal provide a reference signal to be used for time measurement of the ultrasonic waves.

U.S. Patent Application publication no. U.S. 2001/0020936 discloses a coordinate capturing apparatus for inputting hand written characters or diagrams to a computer. This system requires the use of an external clock using light or infrared to provide a timing signal.

U.S. Patent Application publication no. U.S. 2005/0069204 discloses a chirographic signal pulse emitting source and reader system utilizing ultrasonic transducers. As with the other disclosures, this publication discloses utilizing a signal transmission time embedded in the signal. Additionally, the receivers configure to receive the ultrasonic transmissions have a known and fixed location.

Additional other prior art is known relating to touch screens and general ultrasonic transmissions. These systems and methods are often used as graphic input devices for computers, for example various computer mouse configurations and pen-shaped devices for allowing handwriting on a computer screen or to point to a precise location. Some prior art pointing devices contain both a receiver and transmitter and the system measures the Doppler shift of the waves off the writing surface or edges of the writing surface to measure movement. Other prior art devices utilize just a transmitter with the receivers placed at a fixed and known locations. However, none of these disclose the unique features and capabilities of the system and method discloses herein.

It is, therefore, desirable to provide a method and system for positional tracking that requires no phase synchronization between the tracked source and tracking system. It is also desirable to have a method and system that utilizes measurement distances from a relative origin position, eliminating the need to define the exact positions of a tracked target or of the signal receivers. It is, also an object of the subject invention to provide a simple, low cost, and easily implemented tracking system and method.

### SUMMARY OF THE INVENTION

The present invention recognizes and addresses various of the foregoing limitations and drawbacks, and others, concerning position tracking. Therefore, the present invention generally relates to a method and system for relative positional tracking of a signal source that requires no phase synchronization between the tracked source and tracking system. The present invention also utilizes measurement distances from a relative origin position, eliminating the need to define the exact positions of a tracked target or of the signal receivers. The present invention also relates to a method and system that can track an object or human movement for use, for example, in controlling a computer, input information into a handheld device, or manipulating a 2D or 3D virtual environment. The invention can be used to enter drawings, handwriting, or other information, or as a pointing device. The present invention also can track and depict human movement, for example, the swing of a bat, golf club, or racket. The invention is also not limited to use with any particular location or writing surface.

A signal source transmits a repeating signal. The virtual wavelength of the repeating signal establishes zones of coverage, similar in fashion to yardsticks placed end to end in a straight line. Each yardstick represents a zone of coverage. The system's sampling rate (or sync clock) corresponds to the frequency of the repeated signal. One or more transceivers placed within the desired coverage area capture the transmitted signal. Before tracking begins, a coordinate system origin (X=0,Y=0,Z=0) is established so that tracking calculations are relative to the origin. Relative time-of-flight (“TOF”) measurements are made by comparing the received signals against a sync clock. Tracking is accomplished by triangulating distance measurements received from the transceivers. Thus, phase synchronization between the signal source and the sync clock is unnecessary.

Additional objects and advantages of the invention are set forth in, or will be apparent to those of ordinary skill in the art from, the detailed description as follows. Also, it should be further appreciated that modifications and variations to the specifically illustrated and discussed features and materials hereof may be practiced in various embodiments and uses of this invention without departing from the spirit and scope thereof, by virtue of present reference thereto. Such variations may include, but are not limited to, substitutions of the equivalent means, features, and materials for those shown or discussed, and the functional or positional reversal of various parts, features, or the like.

Still further, it is to be understood that different embodiments, as well as different presently preferred embodiments, of this invention, may include various combinations or configurations of presently disclosed features, elements, or their equivalents (including combinations of features or configurations thereof not expressly shown in the figures or stated in the detailed description).

These and other features, aspects and advantages of the present invention will become better understood with reference to the following descriptions and appended claims. The accompanying drawings, which are incorporated in and constitute a part of this specification, illustrate an embodiment of the invention and, together with the descriptions, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a depiction of the wavelength of a 40 kHz transmitter;

FIG. 2 is a depiction of the virtual wavelength of 0.005 sec. with a frequency of 200 Hz using a modulated signal of the 40 kHz transmitter of FIG. 1; and

FIG. 3 is a depiction of the sync clock frequency matched to the transmitter signal in FIG. 2.

FIG. 4 is a depiction of the sync clock frequency reset to the transmitter signal when the origin position is established.

FIG. 5 is a depiction of the phase shift of the received signal after object to be tracked has moved.

FIG. 6 is a depiction of one embodiment of the tracking system to track movement of a pointer or writing device.

FIG. 7 is a depiction of one embodiment used to track movement of a golf club.

Repeated use of reference characters throughout the present specification and appended drawings is intended to represent the same or analogous features or elements of the invention.

### DETAILED DESCRIPTION OF THE PREFERRED EMBODIMENTS

Reference will now be made in detail to presently preferred embodiments of the invention, examples of which are fully represented in the accompanying drawings. Such examples are provided by way of an explanation of the invention, not limitation thereof. In fact, it will be apparent to those skilled in the art that various modifications and variations can be made in the present invention, without departing from the spirit and scope thereof. For instance, features illustrated or described as part of one embodiment can be used on another embodiment to yield a still further embodiment. Still further, variations in selection of materials and/or characteristics may be practiced, to satisfy particular desired user criteria. Thus, it is intended that the present invention cover such modifications and variations as come within the scope of the present features and their equivalents.

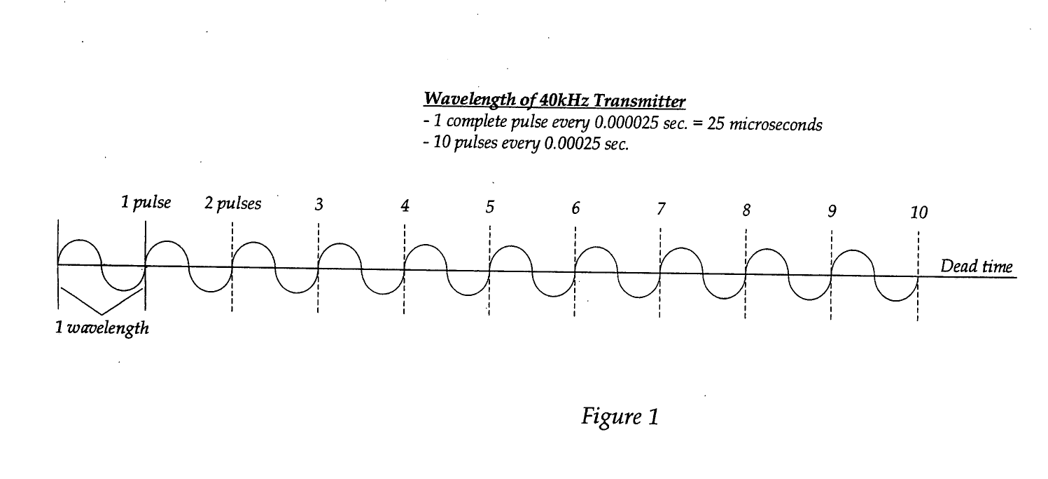

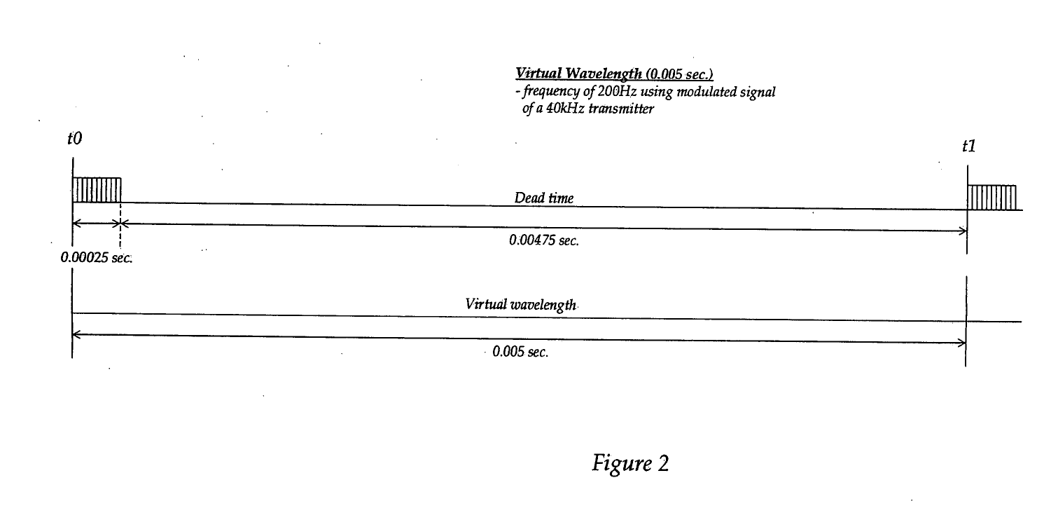

In one preferred embodiment, an ultrasonic source signal (“USS”) is transmitted from the item to be tracked. The USS can be transmitted from any known transmitter, for example, a tracking beacon, pendant, or pointer. In one embodiment, the transmitter does not transmit a continuous signal, but a modulated signal with a period of time where no signal is transmitted, i.e., dead time. Thus, in this embodiment, the transmitted signal has two “wavelengths” associated with it: (1) wavelength of the actual signal transmitted (see FIG. 1); and (2) virtual wavelength of the periodic signal (see FIG. 2). In this embodiment, the transmitter transmits a signal at some selected wavelength, for example 40 kHz, for approximately 10 wavelengths, and the signal is then stopped. In this embodiment, one complete wavelength (or pulse) of the signal is completed every 0.000025 seconds, with the ten wavelengths (or pulses) transmitted signal completed in 0.00025 seconds. This signal of ten wavelengths is referred to as a pulse string. At this point, the transmitted signal is altered, and in this embodiment, the signal is ceased.

As depicted in FIG. 2, after the desired amount of “dead time”, the transmitter is then reactivated and issues another signal. The amount of time (pulse strings plus the deadtime) is referred to as the “virtual wavelength.” The virtual wavelength can be selected and altered by the user depending on the application. For example, if a virtual wavelength of 0.005 sec. with a frequency of 200 Hz (or 200 cycles per second) is desired, and using a 40 kHz wavelength for the USS when transmitting, there would be a transmitted signal for 0.00025 seconds (at a wavelength of 40 kHz), and then “dead time” of 0.00475, for a total cycle time (pulse string plus dead time) of 0.005 seconds. In this embodiment, the system generates 200 cycles per second. The time lag between the leading edge of the first pulse string and the leading edge of the second pulse string is also referred to as the “sampling rate.”

Although the preferred embodiment utilizes a “dead time” where no signal is transmitted, any modulated signal can be used. Thus, instead of utilizing dead time, two different signals could be issued. Also, the amount of pulses (or length of the pulse string) of the USS is not a limitation, and a user could select to issue significantly more or less than 10 pulses.

The “virtual wavelength” selected by the user determines the measurable distance. For example, if a virtual wavelength of 0.005 sec. with a frequency of 200 Hz is selected, and a 40 kHz transmitter is used, the first pulse (or wavelength) of the USS will travel approximately 5.58 feet before the next series of pulses is transmitted (0.005 sec.). Again, this distance is dependent on the virtual wavelength selected by the user, and is also referred to as the “zone of coverage” or “measuring distance.”

Similarly, the user could select a virtual wavelength of 0.0025 sec. with a frequency of 400 Hz. In this case, assuming that a 40 kHz transmitter is used, the time between the first set of pulses and the second set of pulses would be 0.0025 seconds. Thus, the “measuring distance” or “zone of coverage” would thus be approximately 2.79 feet (0.0025 seconds multiplied by 1116.437 feet per second).

In another example, rather than selecting a desired virtual wavelength, a user could first select a desired “zone of coverage” or “measuring distance”. For example, a measuring distance of 7 feet, 5 inches can be selected. In this embodiment, the first pulse of the USS (at 40 kHz) will travel the 7 feet, 5 inches in approximately 0.006643 seconds. In this case, the virtual wavelength of the signal (pulse string plus dead time) is approximately 0.006643 sec. with a frequency of 150.5 cycles per second or 150.5 Hz (1 second divided by 0.006643 cycles/second).

The larger the virtual wavelength frequency, the sampling rate is increased (i.e., there is a shorter time lag between system updates), the more tracking data points can be collected and the more data point resolution is achieved. However, the larger the virtual wavelength frequency (and thus the larger the sampling rate), the smaller the “measurable distance” or “zone of coverage.” For example, in the examples above:

| Virtual Wavelength Freq. | Measurable Distance | Sampling Frequency | |
|---|---|---|---|
| 150 | 7.42 feet | 0.006643 | sec |
| 200 | 5.58 feet | 0.005 | sec |
| 400 | 2.79 feet | 0.0025 | sec |

Thus, the virtual wavelength determines the measurable distance and achievable data point resolution.

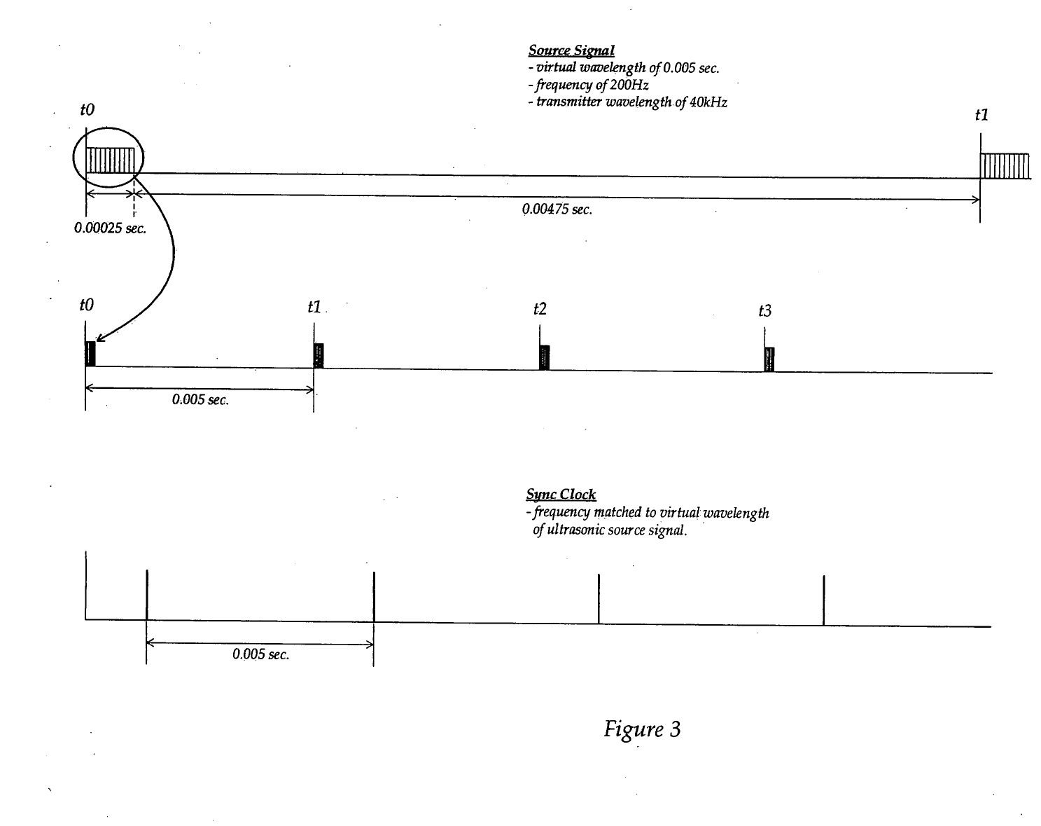

Apart from the transmitter, one or more receivers are provided to receive the transmitted signal. The remainder of the discussion will be with regard to the preferred use of an USS, but other types of transmitted signal could be used, for example, radio frequency or infrared. In the preferred embodiment, an ultrasonic transducer (referred to as a “receiver”) is used to receive the transmitted signal. The receiver preferably includes a sync clock with a frequency closely matched to the virtual wavelength of the USS. The receiver and sync clock are preferably independent of the transmitter. The receiver(s) is placed within the area of coverage of the USS, receives the USS, which is amplified and filtered to create a received signal. The sync clock functions as a relative time base for all time of flight measurements (see FIG. 3).

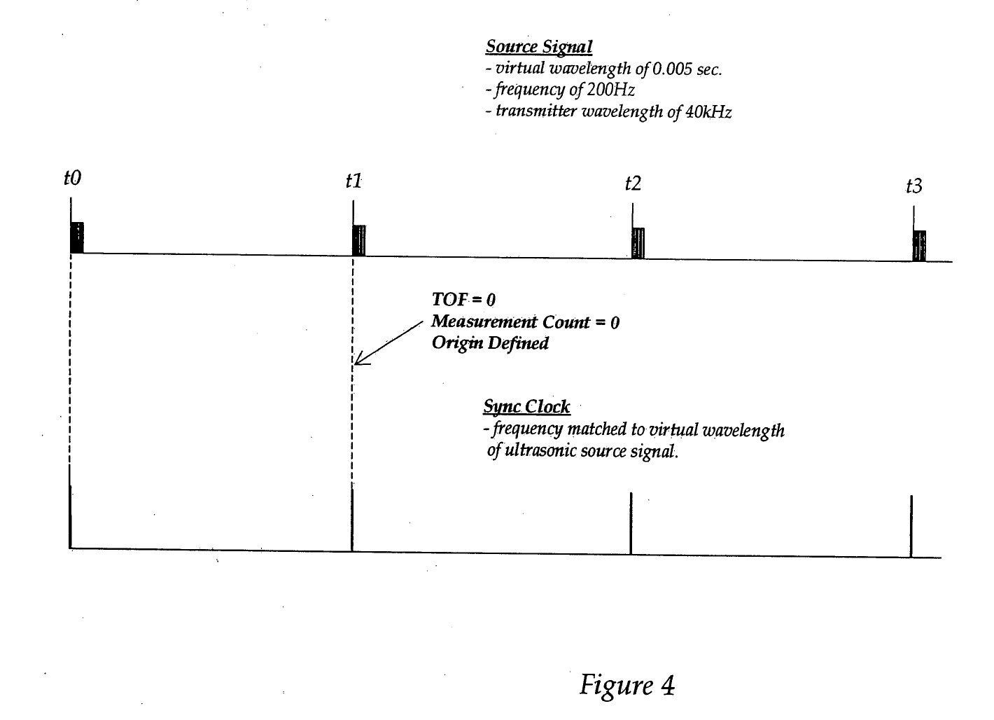

The present system is a relative position system and thus the system does not need to determine the exact origin position of the transmitter (or target). Moreover, one advantage of the invention is that the location of the receivers is not fixed, i.e., they are not tied or limited to any physical location. Indeed, the system does require information regarding the exact location of the transmitter or receivers. The system defines a dynamic origin position from which all measurement calculations are based, and is dependent on the distance of the transmitter to the receiver(s). The origin position is established (X=0, Y=0, Z=0) before any distance measurements are made. Thus, one advantage over the prior art is that the system does not require a “known” location of the source to be tracked. The system may establish an origin position by monitoring the rate of change between TOF readings at the receiver. In the preferred embodiment, to establish an origin position, the transmitter is held steady in a single location. When the rate of change drops to zero (or some sufficiently small amount) and remains there for a short period of time the system sync clock is reset resulting in a measurement count of zero and the defining of an origin position (see FIG. 4). In this manner the origin position can be dynamically assigned to any point within a coverage area. As depicted in FIG. 4, the sync clock is k preferably reset to coincide with the beginning of the pulse string, although not required.

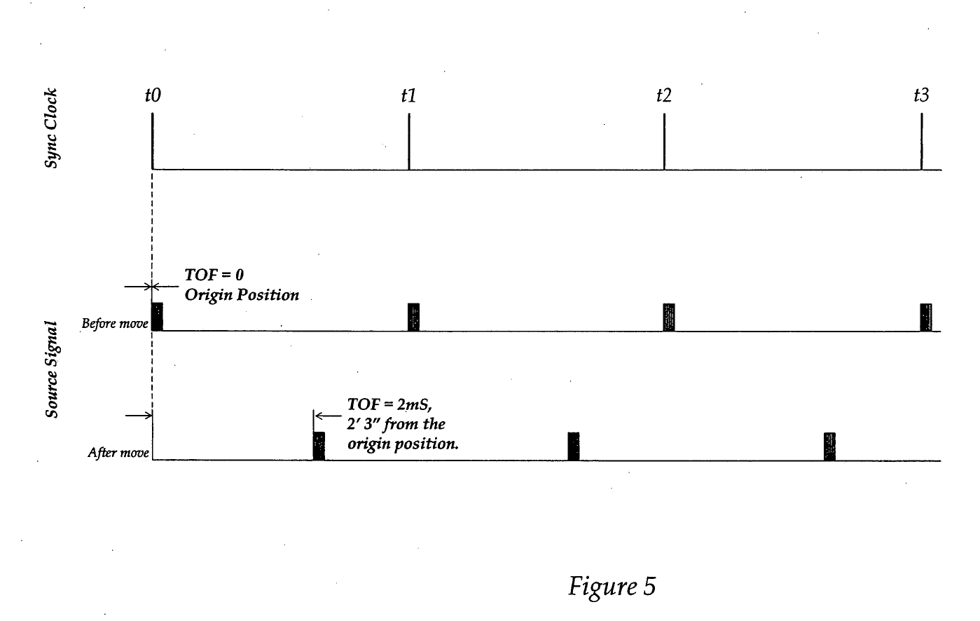

After the origin is established, the system can track movement. As depicted in FIG. 5, as the transmitter (or target) is moved, the TOF measurements to the receivers is changed in proportion to the movement and distance. A microcontroller is used to measure the time shift between the sync clock and the received signal from the transmitter. The resulting TOF measurements, using well-known mathematical techniques, are used to establish the distance between the signal source (transmitter) and the defined origin position. One advantage of the invention is that the system does not have to track the different displacement values for each interval reading, i.e., the displacement since the last measurement to calculate the total displacement in the X, Y, and Z directions. While many prior art systems measure displacement from a last known position, the present invention may measure displacement from a dynamically assigned origin position.

Another advantage of the invention is the ability to use an interrupted signal from the transmitter, i.e., using dead time. This allows the system to save energy and prolong transmitter life. The overall transmission percentage may be below 5 percent, i.e., 5 percent signal pulses and 95 percent dead time. Higher transmission rates percentages are used in most systems (often 100% transmission rates). This is normally required when a system must continually keep track of transitions in phase shift of signals when the system must correct for 360 degree overflow.

The measuring resolution of the system is primarily a function of the microcontroller clocking speed and the bit resolution of the timer used to measure the time of flight of the transmitted signal to the receiver. Any sufficient bit timer can be used, for example an 8 bit timer (up to 255 readings), a 9 bit timer (up to 512 readings), or a 16 bit timer (up to 65,536 readings). The higher the microcontroller clocking speed, the greater the resolution. For example, assuming the user has selected a “measuring distance” (or “zone of coverage”) of 7 feet, 5 inches, an 8 bit timer has a step resolution of 0.348 inches, while a 9 bit timer used over the same distance will result in a step resolution of 0.174 inches. In other words, a relative position measurement will be registered, and can be depicted, if the movement of more than the step resolution, i.e., more than 0.348 inches for an 8 bit timer or more than 0.174 inches for a 9 bit timer.

The system can be used for relative position tracking for both two-dimension and three-dimension applications. A simple two-dimensional tracking system can be implemented with just two ultrasonic transducers spaced several feet apart and oriented at right angles to one another relative to the target. Three-dimensional tracking is accomplished by triangulating relative distance measurements from a multiple of ultrasonic transducers placed within the coverage area. Again, one of the advantages of this invention is that the location of the receivers is not fixed, and does not need to be “known.” The target to be tracked is preferably affixed with an omni directional ultrasonic source that transmits a repeating USS.

The present invention can be used to track human movements.

### EXAMPLE 1

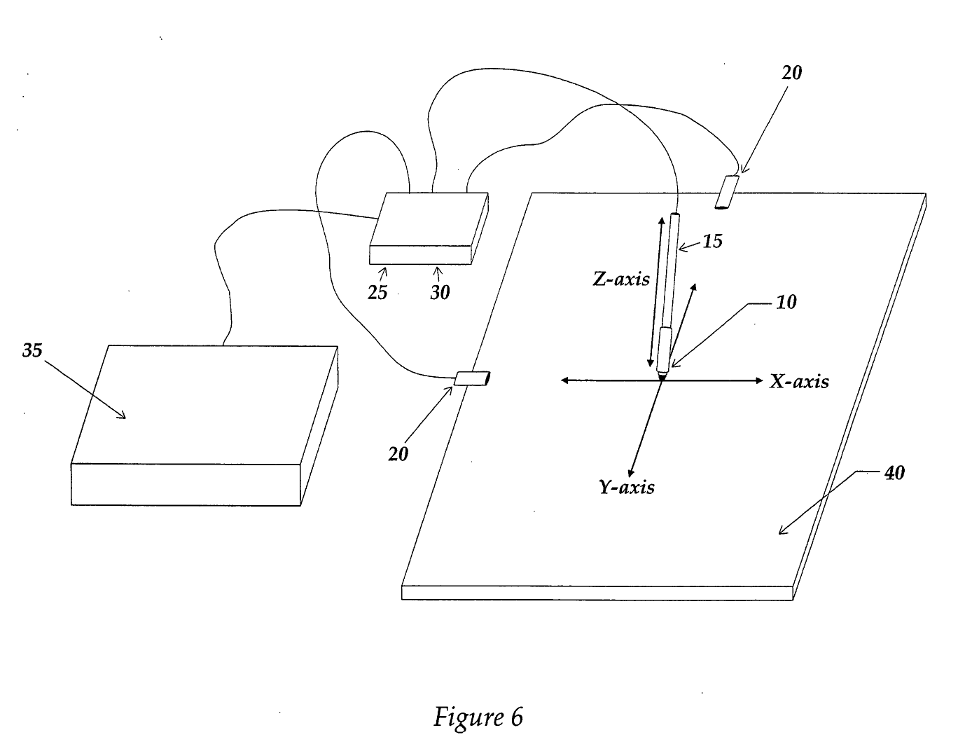

In one embodiment, the present invention can be used to track the movement of a pointer or writing device for direct input into a computer. As depicted in FIG. 6, an omni directional USS 10 is incorporated into the pointer or writing device 15, and is used in conjunction with two or more ultrasonic transducers 20, an ultrasonic driver 25, and a multi-channel ultrasonic receiver 30 with an RS-232 port (the driver and receiver may be housed together). Although FIG. 1 depicts the pointer 15 as directly connected to the ultrasonic receiver 30/ultrasonic driver 25, direct connection is not required. The system is also preferably configured to communicate to a central computer 35 (or control system) for processing. The system is also preferably configured to display the tracked movement on a computer display (not depicted).

If a three-channel three-axis (X-Y-Z) receiver is used, the Z-axis can be assigned a value of 1 due to the two-dimensional application. A communication link, preferably a RS-232 link, is established between the multi-channel ultrasonic receiver 30 and a computer 35 for monitoring and logging of the tracking data. The computer may run a simple ASCII terminal program, although numerous programs may be used. The ultrasonic transducers 20 are preferably placed several feet apart, and preferably oriented at right angles to one another relative to the target. Because the system does not require the transducers 20 to be at any fixed or known location, the user has considerable flexibility in configuring the system for specific tracking applications.

In this embodiment, target movements are limited to the X and Y-axis. Limiting movements to the X and Y-axis may be facilitated by a type of writing board or tablet 40.

One advantage of the invention over some of the prior art systems and methods for computer input devices is that it does not require a writing board, much less continuous contact with the writing board. Moreover, the orientation of the transducers (or receivers) can be manipulated so that different axis are used, for example, if the X and Z-axis were desired for a writing surface that was vertical for a writing board on the wall.

An origin position is established by holding the pointer 15 steady for several seconds. As the pointer 15 (or target) is moved, the system measures the phase shift between the virtual wavelength and the sync clock. Using basic mathematical calculations, the relative movement is calculated as discussed above, recorded and can be depicted in real time on a computer display.

The tracking point data collected may also be processed and filtered to improve the results. For example, the system may filter out any data point that changed more than a threshold amount from the last data point. The system may also perform multiple point moving average. The system may use any standard visualization programs to depict the results.

### EXAMPLE 2

When tracking human movements at a relatively slow speed, such as tracking a pointer or writing implement, a slower sampling rate can be used. However, when tracking fast movement, such as a golf club, bat, or tennis racket, a much higher sampling rate is required.

For example, in an application using a virtual wavelength of 0.006643 sec. with a frequency of approximately 150 Hz (or cycles per second), and a measuring distance of approximately 7 feet 5 inches, an object traveling at 100 mph can cover that distance in 51 ms. Multiplying the sampling rate by the minimum time it takes an object to cover the measuring distance yields the worst case or minimum number of data points that will be taken (151.9 Hz*51 ms=7.7469) for the given period of time. Obviously 7 data points would be insufficient to accurately track a fast moving object across 7′5″.

Sixty data points, for example, would work much better for tracking a golf club swing over a 12′ area. An object traveling at 100 mph would take about 81.8 ms to travel 12′ and require a 734 Hz-sampling rate. A 734 Hz-sampling rate results in a measure distance of about 1′6″. This would be an acceptable sampling rate if the distance were greater. Thus, the system needs to increase measuring distance without decreasing the sampling rate. It is possible to maintain an adequate sampling rate and increase the measuring distance by creating zones of coverage. A single zone of coverage in this embodiment is equal in length to the defined measuring distance established by the USS wavelength. All TOF measurements in this embodiment with multiple zones of coverage are made as previously described above. When a single zone of coverage is crossed by the object to be tracked, the total displacement is simply the size of the zone of coverage plus the measured displacement of the registered zone of coverage.

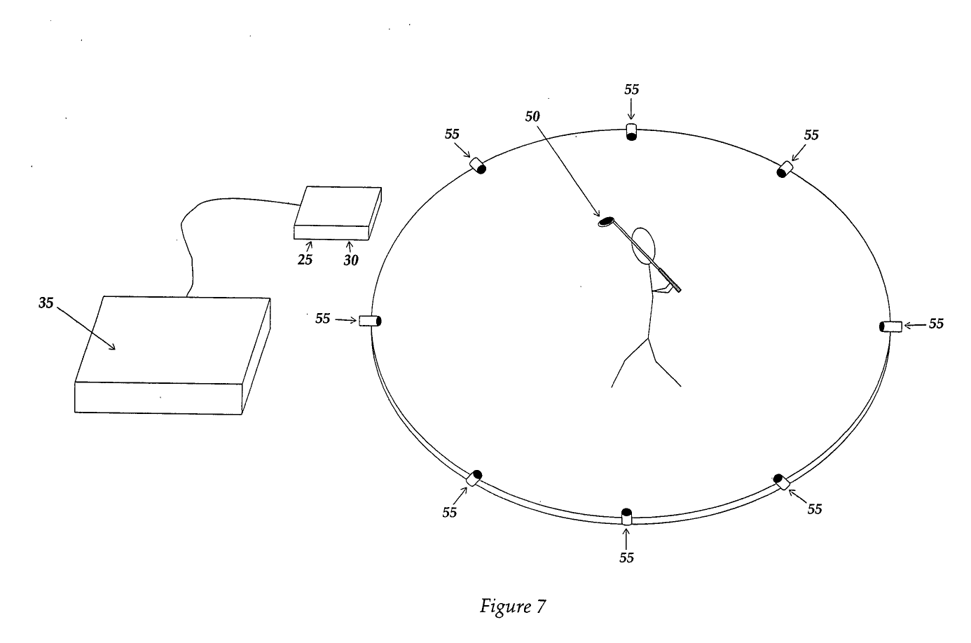

Depicted in FIG. 7 is one possible configuration for tracking a golf club swing. Similar configurations could be used for tracking other movements, for example a tennis racket swing or baseball bat swing. In this embodiment, an ultrasonic source signal 50 is attached to the golf club head, or other portion to be tracked. A plurality of transducers 55 are arranged to receive the signals. Similar to the system disclosed in FIG. 6, the system preferably utilizes an ultrasonic receiver 30 and ultrasonic driver 25, and central computer 35 for processing the signals. The relative movement of the item to be tracked is measured and displayed as discussed above.

Additional embodiments contemplated herein including tracking movement of humans or objects in a building. In this embodiment, transmitters could be attached to the object to be tracked and various receivers configured to receive those signals.

Although a preferred embodiment of the invention has been described using specific terms and devices, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of various other embodiments may be interchanged both in whole or in part. Therefore, the spirit and scope of the appended claims should not be limited to the description of the preferred version contained herein.

What is claimed is:

1. A computer input system comprising
(a) an input device containing an ultrasonic transmitter that generates a transmitter signal having a virtual wavelength and associated frequency;
(b) a plurality of receivers remotely located from the transmitter configured to receive the transmitter signal;
(c) a sync clock remotely located from the transmitter that generates a signal having a frequency corresponding to the virtual wavelength and associated frequency of the transmitter signal; and
(d) a control system;
wherein the control system is operative to calculate the relative movement of the input device from a dynamically assigned origin position based on the phase shift of the transmitter signal relative to the sync clock signal.

2. The system of claim 1 wherein the exact location of the receivers is not known.

3. The system of claim 1 wherein the transmitter signal has a transmission rate of less than about 20%

4. The system of claim 1 wherein the receivers are configured to track three dimensional movement and all relative movements of the input device are calculated by triangulating distances.

5. A method of tracking an object comprising the steps of:
(a) transmitting a signal having a virtual wavelength and associated frequency from an object to be tracked;
(b) receiving the transmitted signal at remotely located receivers, said receivers having an independently generated internal signal having a frequency corresponding to the virtual wavelength and associated frequency of the transmitted signal; and
(c) determining an indication of relative movement of the object to be tracked based on the phase shift between the transmitted signal and internal receiver signal.

6. The method of claim 5 wherein the location of the object to be tracked is not known.

7. The method of claim 5 wherein the origin position of the object to be tracked is dynamically assigned.

8. The method of claim 7 wherein the origin position in established when the phase shift between the transmitter signal and receiver signal falls below a predetermined threshold value.

9. The method of claim 5 further comprising the step of processing the indication of the relative movement of the object to be tracked to filter out any movement indication that exceeds a predetermined threshold value.

10. The method of claim 5 further comprising displaying the relative movement of the object in real time.

11. The method of claim 5, wherein the location of the receivers is not known.

12. The method of claim 5 wherein the step of determining an indication of relative movement of the object to be tracked are all measured from a dynamically assigned origin position.

13. The method of claim 5 wherein the object to be tracked is sporting goods equipment.

14. The method of claim 5 wherein the transmitted signal has a transmission rate of less than 20%.

15. A relative position detection system comprising:
(a) a signal transmitter generating a modulated transmitter signal having a virtual wavelength and associated frequency;
(b) a plurality of remotely located, unfixed, receivers configured to receive the modulated transmitter signal and configured to generate an independent, internal, receiver timing signal having a frequency corresponding to the virtual wavelength and associated frequency of the signal transmitter; and
(c) a control system,
wherein the control system measures the relative movement of the signal transmitter based on the phase shift between the transmitter signal and the receiver timing signal.

16. The system of claim 15 wherein an origin position from which the relative movement is measured is dynamically assigned.

17. The system of claim 16 wherein all relative movement measurements are relative to the origin position.

18. The system of claim 16 wherein the receiver timing signal is reset to coincide with the transmitter signal when the origin position is assigned.

19. The system of claim 15 wherein the location of the signal transmitter and receivers is not known.

20. The system of claim 15 wherein the transmitter signal is ultrasound.
